(19) United States
(12) Patent Application Publication
(10) Pub. No.: US 2017/0369311 A1
(43) Pub. Date: Dec. 28, 2017

(54) METHODS FOR CONVERSION OF METHANE TO SYNGAS

(71) Applicant: SABIC Global Technologies B.V., Bergen op Zoom (NL)

(72) Inventor: Aghaddin MAMEDOV, Sugar Land, TX (US)

(21) Appl. No.: 15/542,704

(22) PCT Filed: Feb. 4, 2016
(86) PCT No.: PCT/US2016/016503

§ 371 Date: Jul. 11, 2017

Related U.S. Application Data
(60) Provisional application No. 62/116,134, filed on Feb. 13, 2015.

(51) Int. Cl. C01B 3/40; B01J 23/889; B01J 8/02; B01J 35/02; B01J 38/12; B01J 23/00; B01J 23/94

(52) U.S. Cl. CPC C01B 3/40; B01J 23/002; B01J 23/8892; B01J 23/94; B01J 35/023; B01J 38/12; B01J 8/02; B01J 2523/00; C01B 2203/0238; C01B 2203/1041; C01B 2203/1058; C01B 2203/1241; B01J 2208/02

(57) ABSTRACT

Methods and systems for converting methane to syngas are provided. Certain exemplary methods and systems involve reacting methane and carbon dioxide with a nickel oxide catalyst in a reaction chamber, thereby providing syngas and a reduced nickel species. The reduced nickel species can be regenerated by oxidation with air in a regeneration chamber, thereby generating a regenerated nickel oxide and heat. The regenerated nickel oxide and heat can be returned to the reaction chamber to drive the syngas reaction.

### CROSS-REFERENCE TO RELATED APPLICATIONS

This application claims the benefit of priority of U.S. Provisional Patent Application No. 62/116,134, filed Feb. 13, 2015, which is hereby incorporated by reference in its entirety.

### FIELD

The presently disclosed subject matter relates to methods and systems for conversion of methane to synthesis gas (syngas).

### BACKGROUND

Synthesis gas, also known as syngas, is a gas mixture containing hydrogen (H₂) and carbon monoxide (CO). Syngas can also include carbon dioxide (CO₂). Syngas is a chemical feedstock that can be used in numerous applications. For example, syngas can be used to prepare liquid hydrocarbons, including olefins (e.g., ethylene (C₂H₄)), via the Fischer-Tropsch process. Syngas can also be used to prepare methanol (CH₃OH).

Syngas is commonly generated on large scale from methane (CH₄), e.g., through steam reforming processes or through oxidative reforming with oxygen (O₂). Existing processes can suffer from drawbacks. For example, steam reforming processes can be affected by coke formation, which can necessitate periodic catalyst regeneration. Steam reforming processes can also be highly endothermic and energy intensive. Oxidative reforming with oxygen can be highly exothermic and can consequently cause problematic exotherms.

An alternative method for conversion of methane to syngas can be autothermal reforming. In autothermal reforming, a portion of methane can be combusted with oxygen to provide carbon dioxide and water, according to chemical equation (1):

CH₄+2O₂→CO₂+2H₂O (1)

The combustion reaction is exothermic and provides heat. Further portions of methane can then undergo dry reforming with carbon dioxide according to chemical equation (2) and steam reforming with water according to chemical equation (3) to provide syngas:

CH₄+CO₂→2CO+2H₂ (2)

CH₄+H₂O→CO+3H₂ (3)

The heat provided by the combustion reaction (1) can drive the endothermic dry reforming (2) and steam reforming (3) reactions. In this way, energy consumption can be reduced as compared to standard dry reforming and steam reforming processes.

However, autothermal reforming processes as outlined above can have drawbacks. Autothermal reforming can require the use of pure oxygen in the combustion step. Pure oxygen can be an expensive feedstock.

Thus, there remains a need for improved methods and systems for conversion of methane to syngas, including methods and systems that avoid the need for pure oxygen as a feedstock while also reducing overall energy consumption.

### SUMMARY OF THE DISCLOSED SUBJECT MATTER

The presently disclosed subject matter provides methods and systems for conversion of methane to syngas, i.e., methods and systems for preparing syngas from methane.

In one embodiment, an exemplary method of preparing syngas can include providing a reaction chamber and a regeneration chamber. The reaction chamber can include a nickel oxide. The method can further include feeding methane and carbon dioxide to the reaction chamber, thereby contacting methane and carbon dioxide with the nickel oxide to provide syngas and a reduced nickel species. The method can further include removing the reduced nickel species from the reaction chamber to the regeneration chamber. The method can further include feeding air to the regeneration chamber, thereby contacting air with the reduced nickel species to provide a regenerated nickel oxide and heat. The method can further include removing the regenerated nickel oxide and heat from the regeneration chamber to the reaction chamber.

In one embodiment, an exemplary system for use in conversion of methane to syngas can include a reaction chamber, a regeneration chamber, and a circulation system. The reaction chamber can include a reduced nickel species. The regeneration chamber can include a regenerated nickel oxide. The circulation system can be configured to feed reduced nickel species from the reaction chamber to the regeneration chamber and to feed regenerated nickel oxide from the regeneration chamber to the reaction chamber.

In certain embodiments, the nickel oxide can include a solid support. The solid support can include an oxide selected from the group consisting of aluminum oxide, magnesium oxide, and silicon oxide.

The nickel oxide can include particles having a diameter between about 200 μm and about 400 μm.

In certain embodiments, the nickel can include a promoter. The promoter can include an oxide selected from the group consisting of lanthanum(III) oxide, cerium(III) oxide, platinum(II) oxide, barium oxide, calcium oxide, and potassium oxide.

In certain embodiments, the temperature in the reaction chamber can be between about 650° C. and about 1050° C. The temperature in the reaction chamber can be between about 750° C. and about 850° C. In certain embodiments, the temperature in the regeneration chamber can be between about 450° C. and about 850° C. The temperature in the regeneration chamber can be between about 550° C. and about 750° C.

In certain embodiments, the method can include removing CO₂ from the regeneration chamber to the reaction chamber.

In certain embodiments, the system can include a riser column.

### BRIEF DESCRIPTION OF THE DRAWINGS

FIG. 1 is a schematic diagram showing an exemplary system that can be used in conjunction with methods for conversion of methane to syngas in accordance with the presently disclosed subject matter.

FIG. 2 is another schematic diagram showing an exemplary system that can be used in conjunction with methods for conversion of methane to syngas in accordance with the presently disclosed subject matter.

### DETAILED DESCRIPTION

The presently disclosed subject matter provides methods and systems for conversion of methane to synthesis gas (syngas), i.e., mixtures of carbon monoxide and hydrogen. As noted above, there is a need for improved methods and systems that can provide syngas from methane without the need for expensive pure oxygen and with improved energy efficiency. The presently disclosed subject matter provides methods and systems in which methane is reacted with carbon dioxide and a nickel oxide catalyst, e.g., Ni-based mixed oxides. The reaction can be carried out in a reaction chamber wherein carbon monoxide, hydrogen, and water are formed along with a reduced nickel species. The reduced nickel species can be coated with coke particles. The reduced nickel species can be circulated by a circulation system out of the reaction chamber and into a regeneration chamber. Air can be fed into the regeneration chamber, and the reduced nickel species can be combusted to provide a regenerated nickel oxide. Coke particles on the nickel species can also be combusted, generating carbon dioxide and heat. The regenerated nickel oxide can then be circulated by the circulation system back to the reaction chamber, to catalyze further reactions of methane. Carbon dioxide and heat generated in the regeneration chamber can also be circulated into the reaction chamber, to drive the reaction of methane to syngas. In this way, air can be used as an oxidant rather than pure oxygen and overall energy consumption can be reduced. The presently disclosed methods and systems can have advantages over existing methods and systems, as described below, including improved efficiency, reduced energy consumption, and reduced cost.

As used herein, the term “about” or “approximately” means within an acceptable error range for the particular value as determined by one of ordinary skill in the art, which will depend in part on how the value is measured or determined, i.e., the limitations of the measurement system. For example, “about” can mean a range of up to 20%, up to 10%, up to 5%, and or up to 1% of a given value.

### Reaction and Regeneration Steps

The reaction of methane with carbon dioxide and a nickel oxide can be described as an oxidation of methane and can be denoted a “reaction step” according to chemical equation (4):

2CH₄+CO₂+NiO→2CO+3H₂+H₂O+Ni.C* (4)

“NiO” represents a generic nickel oxide and does not necessarily represent nickel(II) oxide (NiO) specifically; NiO can also represent Ni(III) oxide (Ni₂O₃) as well as mixed nickel oxides, e.g., a mixture of Ni(II) and Ni(III) oxides. “Ni.C*” represents a generic reduced nickel species, which can be coated with coke particles (solid particles of carbon). Ni.C* can represent nickel in various oxidation states, e.g., metallic nickel (Ni(0)) or a mixture of Ni(0) and Ni(II), and with various amounts of coke present. The reaction step can provide a mixture of carbon monoxide, hydrogen, water, and reduced nickel species. The reaction step can be endothermic and can consume heat.

The reaction of a reduced nickel species with oxygen can be described as an oxidation of the reduced nickel species and can be denoted a “regeneration step” according to chemical equation (5):

Ni.C*+O₂→NiO+CO₂ (5)

“O₂” represents molecular oxygen, but it should be understood that the source of oxygen does not have to be pure oxygen but can instead include more dilute sources of oxygen, e.g., air. The regeneration step can provide a regenerated nickel oxide and carbon dioxide. The regeneration step can be exothermic and can generate heat.

The reaction step according to chemical equation (4) and the regeneration step according to chemical equation (5) can be combined into an overall chemical process (6):

2CH₄+1.5O₂→2CO+3H₂+H₂O (6)

Because the nickel oxide consumed in the reaction step (4) and regenerated in the regeneration step (5), nickel is recycled through the overall process (6) and can be used catalytically.

### Nickel Oxides

The nickel oxide used can include Ni(II) oxide, Ni(III) oxide, and combinations thereof. The nickel oxide can be a mixed nickel oxide, e.g., a mixture of Ni(II) and Ni(III) oxides. The nickel oxide can include some amount of metallic nickel, i.e., Ni(0).

The nickel oxide can include one or more additional metals. In certain embodiments, the additional metal(s) can be described as a promoter. In certain embodiments, the additional metal(s) can be a metal that, when incorporated with a nickel oxide or other nickel species, can change the redox properties of the nickel oxide or other nickel species. For example, the additional metal(s) can accelerate oxidation of a reduced nickel species to a nickel oxide. Acceleration of the oxidation of a reduced nickel species to a nickel oxide can reduce the amount of metallic nickel (Ni(0)) present in a system and can reduce coke formation. In certain embodiments, the metal(s) can be a metal that, when incorporated with a nickel oxide or other nickel species, can make the nickel species more basic, which can reduce coke formation.

By way of non-limiting example, the nickel oxide can include one or more additional metal oxides selected from the group consisting of chromium oxides (e.g., Cr₂O₃), manganese oxides (e.g., MnO, MnO₂, Mn₂O₃, or Mn₂O₇), copper oxides (e.g., CuO), tungsten oxides (e.g., WO₃), lanthanum oxides (e.g., La₂O₃ (lanthanum(III) oxide)), cerium oxides (e.g., Ce₂O₃ (cerium(III) oxide)), platinum oxides (e.g., PtO (platinum(II) oxide), thorium oxides (e.g., ThO₂ (thorium(IV) oxide)), tungsten oxides (e.g., WO₃ (tungsten(VI) oxide)), indium oxides (e.g., In₂O₃ (indium(III) oxide)), barium oxides (e.g., BaO), calcium oxides (e.g., CaO), and potassium oxides (e.g., K₂O), and combinations thereof. In certain embodiments, the nickel oxide can include a promoter that includes one or more oxide selected from the group consisting of lanthanum(III) oxide, cerium(III) oxide, platinum(II) oxide, barium oxide, calcium oxide, and potassium oxide. In certain embodiments, the catalyst can include oxides of two, three, four, or more different metals (elements).

The nickel oxide can include a solid support. That is, the nickel oxide can be solid-supported. In certain embodiments, the solid support can include various metal salts, metalloid oxides, and metal oxides, e.g., titania (titanium oxide), zirconia (zirconium oxide), silica (silicon oxide), alumina (aluminum oxide), thoria (thorium oxide), magnesia (magnesium oxide), and magnesium chloride. In certain embodiments, the solid support can include aluminum oxide (Al₂O₃), silicon oxide (SiO₂), magnesium oxide (MgO), or a combination thereof. In certain embodiments, the solid support can include lanthanum(III) oxide (La₂O₃). When the nickel oxide includes a solid support, the catalyst can include nickel in an amount between about 2% and about 15%, by weight overall, relative to the total weight of the catalyst, and the remainder of the catalyst can be solid support and, optionally, promoter. In certain embodiments, the catalyst can include nickel in an amount between about 8% and about 10%, by weight overall, relative to the total weight of the catalyst. In certain embodiments, the catalyst can include a promoter (additional metal(s)) in an amount between about 4% and about 5%, by weight overall, relative to the total weight of the catalyst.

In certain embodiments, the nickel oxide can be used without a solid support. That is, the nickel oxide can be used as a bulk oxide.

The nickel oxide, when used with or without a solid support, can have a defined particle size or diameter. The diameter can be characterized as the median diameter of the particle distribution. In certain embodiments, the nickel oxide can include particles having a diameter between about 150 μm and about 600 μm, e.g., about 150 μm, about 200 μm, about 250 μm, about 300 μm, about 350 μm, about 400 μm, about 450 μm, about 500 μm, about 550 μm, or about 600 μm. In certain embodiments, the nickel oxide can include particles having a diameter between about 150 μm and about 350 μm or between about 200 μm and about 400 μm. The nickel oxide can be in the form of granules, pellets, and/or other particles.

### Systems and Methods for Conversion of Methane to Syngas

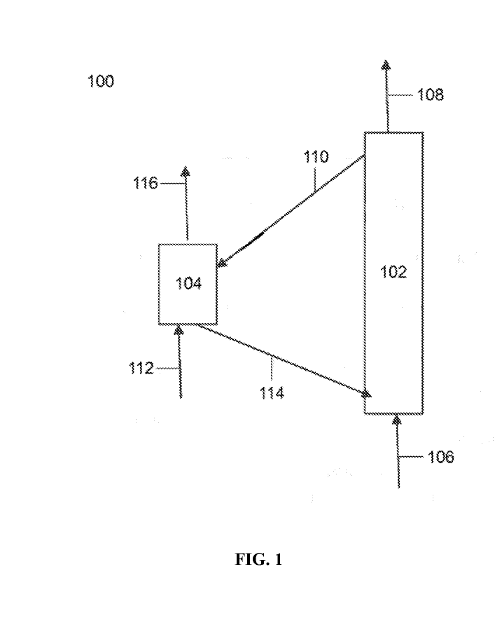

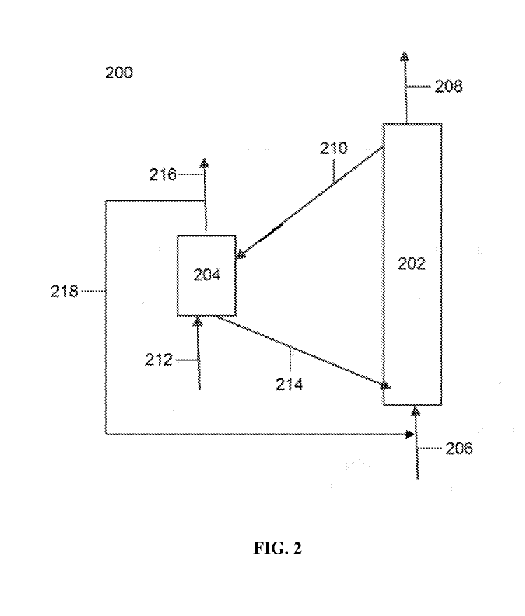

For the purpose of illustration and not limitation, FIGS. 1 and 2 are schematic representations of exemplary systems that can be used in conjunction with the methods of the presently disclosed subject matter. The system 100, 200 can include a reaction chamber 102, 202 and a regeneration chamber 104, 204. The reaction chamber 102, 202 can include a reduced nickel species. The regeneration chamber 104, 204 can include a regenerated nickel oxide. The system 100, 200 can further include a circulation system that connects the reaction chamber 102, 202 and the regeneration chamber 104, 204. The circulation system can be configured to feed reduced nickel species from the reaction chamber 102, 202 to the regeneration chamber 104, 204 via a stream 110, 210 and to feed regenerated nickel oxide from the regeneration chamber 104, 204 to the reaction chamber 102, 202 via a stream 114, 214.

The reaction chamber 102, 202 and regeneration chamber 104, 204 can be of various designs known in the art. In certain embodiments, the chambers 102, 104, 202, 204 can be fixed bed plug flow reactors. In certain embodiments, the chambers 102, 104, 202, 204 can be fluidized bed or riser-type reactors. In certain embodiments, the system 100, 200 can include a riser column.

In an exemplary embodiment, a method of preparing syngas can include providing a system 100, 200 as outlined above that includes a reaction chamber 102, 202 and a regeneration chamber 104, 204. The reaction chamber 102, 202 can include a nickel oxide. Methane and carbon dioxide can be fed to the reaction chamber 102, 202 through a stream 106, 206. The methane and carbon dioxide fed to the reaction chamber 102, 202 can be dry (i.e., free or substantially free of water). The method can be a continuous method. In other words, the system 100, 200 can be operated continuously.

In certain embodiments, the ratio of methane to carbon dioxide (CH₄:CO₂) fed to the reaction chamber 102, 202 can be between about 2:1 and about 1:2, mole:mole. In certain embodiments, the ratio of methane to carbon dioxide (CH₄:CO₂) fed to the reaction chamber 102, 202 can be about 2:1. Variation of the ratio of methane to carbon dioxide can influence the composition of the syngas formed by the system 100, 200.

Methane and carbon dioxide can be contacted with the nickel oxide catalyst within the reaction chamber 102, 202 to provide syngas (carbon monoxide and hydrogen) as well as water. Syngas thereby prepared can be removed from the reaction chamber 102, 202 through a product stream 108, 208. Water can also be removed through the stream 108, 208.

In certain embodiments, the syngas removed through the product stream 108, 208 can have a hydrogen:carbon monoxide (H₂:CO) ratio of between about 1.5:1 and about 3:1, e.g., about 2:1.

In certain embodiments, water can be separated from syngas in the product stream 108, 208. Water can be separated by methods known in the art. By way of non-limiting example, water can be separated by condensation, e.g., by cooling the product stream 108, 208.

During the reaction step, the nickel oxide can be reduced to a reduced nickel species, as presented in chemical equation (4). The reduced nickel species can be ineffective as a catalyst for conversion of methane and carbon dioxide to syngas. At least a portion of the reduced nickel species can be removed from the reaction chamber 102, 202 to the regeneration chamber 104, 204 through a stream 110, 210. In certain embodiments, particles of nickel species removed from the reaction chamber 102, 202 to the regeneration chamber 104, 204 through the stream 110, 210 can be fully reduced to metallic nickel, which can be coated in coke particles. Air can be fed into the regeneration chamber 104, 204 through a stream 112, 212. Air can thereby be contacted with the reduced nickel species to combust (oxidize) the reduced nickel species. Any coke residue on the reduced nickel species can be oxidized as well. Contacting air with the reduced nickel species within the regeneration chamber 104, 204 can therefore provide a regenerated nickel oxide and heat in a regeneration step, as presented in chemical equation (5). The regeneration step can also generate carbon dioxide, as shown in chemical equation (5).

At least a portion of the regenerated nickel oxide and heat generated from the regeneration step can then be removed from the regeneration chamber 104, 204 to the reaction chamber 102, 202 through a stream 114, 214. In certain embodiments, particles of nickel species removed from the regeneration chamber 104, 204 to the reaction chamber 102, 202 through the stream 114, 214 can be fully oxidized to regenerated nickel oxide. A stream of carbon dioxide 116, 216 can be removed from the regeneration chamber 104, 204. In certain embodiments, at least a portion of carbon dioxide can be removed from the regeneration chamber 204 to the reaction chamber 202 through a stream 218.

In certain embodiments, the system 100, 200 can be operated in a mode analogous to a fluid catalytic cracking (FCC) system. For example, one or more feeds of methane and carbon dioxide (e.g., stream 106, 206) can be used to drive particles of nickel species (e.g., nickel oxide and/or reduced nickel species) through a reaction chamber 102, 202 and into a regeneration chamber 104, 204 through a stream 110, 210. One or more feeds of oxygen (e.g., a stream of air 112, 212) can keep the particles of nickel species fluidized. The particles of nickel species (e.g., reduced nickel species) can be regenerated in the regeneration chamber 104, 204 (e.g., to provide regenerated nickel oxide) and then removed to the reaction chamber 102, 202 (e.g., through a stream 114, 214).

In certain embodiments, the temperature in the reaction chamber 102, 202 can be between about 650° C. and about 1050° C., e.g., about 650° C., about 700° C., about 750° C., about 800° C., about 850° C., about 900° C., about 950° C., about 1000° C., or about 1050° C. The temperature in the reaction chamber 102, 202 can be between about 750° C. and about 850° C.

In certain embodiments, the temperature in the regeneration chamber 104, 204 can be between about 450° C. and about 850° C., e.g., about 450° C., about 500° C., about 550° C., about 600° C., about 650° C., about 700° C., about 750° C., about 800° C., or about 850° C. The temperature in the regeneration chamber 104, 204 can be between about 550° C. and about 750° C.

Various nickel species (nickel oxides (including regenerated nickel oxides) and reduced nickel species) can be circulated between the reaction chamber 102, 202 and regeneration chamber 104, 204. The nickel species can remain solid and can be circulated as solid particles. The nickel species can remain stable at the temperatures within the reaction chamber 102, 202 and regeneration chamber 104, 204, e.g., up to about 850° C., about 900° C., about 950° C., about 1000° C., about 1050° C., or above 1050° C.

The system 100, 200 can be scaled depending on the desired scale of syngas production. By way of non-limiting example, a laboratory-scale system 100, 200 can include reaction and regeneration chambers 102, 202, 104, 204 with diameters of about 15 mm to about 20 mm. In such embodiments, the quantity of particles of nickel species circulating through the system 100, 200 can be between about 70 mL and about 200 mL, e.g., about 100 mL.

In certain embodiments, the gas hourly space velocity (GHSV) of the system 100, 200 can be between about 3600 h⁻¹ and about 8000 h⁻¹, e.g., about 5000 h⁻¹. In certain embodiments, the pressure within the system 100, 200 can be approximately atmospheric pressure (e.g., about 1 bar).

In certain embodiments, the linear space velocity of gas through the reaction chamber 102, 202 and regeneration chamber 104, 204 can have a linear space velocity of between about 4 m/second and about 6 m/second. In certain embodiments, the linear space velocity of gas through the chambers 102, 202, 104, 204 can be adjusted to promote circulation of catalyst particles through the system 100, 200 (e.g., through the streams 110, 210, 114, 214).

When heat is removed from the regeneration chamber 104, 204 to the reaction chamber 102, 202 through a stream 114, 214, heat generated by the regeneration step can be applied to the reaction step. In this way, the exothermic regeneration step can be used to drive the endothermic reaction step, reducing the need to apply heat from external sources to the reaction chamber 102, 202. Removing heat from the regeneration chamber 104, 204 to the reaction chamber 102, 202 can therefore reduce energy consumption and improve the overall economy of the process. In certain embodiments, heat and catalyst can be circulated through the same stream 114, 214.

When carbon dioxide is removed from the regeneration chamber 204 to the reaction chamber 202 through a stream 218, carbon dioxide can be recycled through the system and reacted with methane to provide syngas. In this way, input of carbon dioxide through the stream 206 can be reduced, thereby improving the overall economy of the process.

As noted above, the methods and systems of the presently disclosed subject matter can have certain advantages over certain existing processes for converting methane into syngas. Because the presently disclosed systems and methods can use air rather than pure oxygen as oxidant, use of expensive oxygen can be avoided, thereby improving economy. Carbon dioxide generated in the course of the presently disclosed methods can be recycled into the syngas preparation reaction, which can reduce the need for external sources of carbon dioxide and further improve economy. The regeneration step of the presently disclosed subject matter can provide heat to the reaction step, which can reduce energy consumption and can again improve economy. Nickel catalyst can be circulated through the systems of the presently disclosed subject matter, regenerating the catalyst in situ and obviating the need for a separate catalyst regeneration step, which can further improve economy and efficiency.

### EXAMPLES

### Example 1. Preparation of Syngas

Syngas was prepared using separated, alternated cycles of reaction and catalyst (nickel oxide) regeneration, using a fixed bed reactor. A fixed bed reactor was charged with 8 mL of a lanthanum (La) and manganese (Mn) mixed oxide catalyst. Methane and carbon dioxide in a CH₄:CO₂ ratio of 2:1 (mole:mole) were fed into the reactor. The reactor temperature was 850° C. The contact time was 1 second. The flow rate of the methane and carbon dioxide mixture was 480 mL/minute.

Syngas was removed from the reactor. The conversion of methane was 80%, and the conversion of carbon dioxide was 85%.

The feed of methane and carbon dioxide was then replaced with air. In this way, the reactor was switched from a reaction mode to a regeneration mode. Carbon dioxide was removed from the reactor, indicating combustion of coke particles on the catalyst. Ten (10) minutes after air was first fed to the reactor, carbon dioxide formation decreased significantly, indicating full combustion of coke fragments on the catalyst and regeneration of the catalyst. Air was fed to the reactor for a total of 20 minutes. The feed of air was then replaced with a feed of methane and carbon dioxide, completing the reaction cycle.

Although the presently disclosed subject matter and its advantages have been described in detail, it should be understood that various changes, substitutions and alterations can be made herein without departing from the spirit and scope of the disclosed subject matter as defined by the appended claims. Moreover, the scope of the disclosed subject matter is not intended to be limited to the particular embodiments described in the specification. Accordingly, the appended claims are intended to include within their scope such alternatives.

1. A method for preparing syngas, comprising:
a. providing a reaction chamber and a regeneration chamber, wherein the reaction chamber comprises a nickel oxide;
b. feeding methane and carbon dioxide to the reaction chamber, thereby contacting methane and carbon dioxide with the nickel oxide to provide syngas and a reduced nickel species;
c. removing the reduced nickel species from the reaction chamber to the regeneration chamber;
d. feeding air to the regeneration chamber, thereby contacting air with the reduced nickel species to provide a regenerated nickel oxide and heat; and
e. removing the regenerated nickel oxide and heat from the regeneration chamber to the reaction chamber.

2. The method of claim 1, wherein the nickel oxide comprises a solid support.

3. The method of claim 2, wherein the solid support comprises an oxide selected from the group consisting of aluminum oxide, magnesium oxide, and silicon oxide.

4. The method of claim 1, wherein the nickel oxide comprises particles having a diameter between about 200 μm and about 400 μm.

5. The method of claim 1, wherein the nickel oxide comprises a promoter.

6. The method of claim 5, wherein the promoter comprises an oxide selected from the group consisting of lanthanum(III) oxide, cerium(III) oxide, platinum(II) oxide, barium oxide, calcium oxide, and potassium oxide.

7. The method of claim 1, wherein the temperature in the reaction chamber is between about 650° C. and about 1050° C.

8. The method of claim 7, wherein the temperature in the reaction chamber is between about 750° C. and about 850° C.

9. The method of claim 1, wherein the temperature in the regeneration chamber is between about 450° C. and about 850° C.

10. The method of claim 9, wherein the temperature in the regeneration chamber is between about 550° C. and about 750° C.

11. The method of claim 1, further comprising removing carbon dioxide from the regeneration chamber to the reaction chamber.

12. A system for use in conversion of methane to syngas, comprising:
a. a reaction chamber comprising a reduced nickel species;
b. a regeneration chamber comprising a regenerated nickel oxide; and
c. a circulation system configured to feed reduced nickel species from the reaction chamber to the regeneration chamber and to feed regenerated nickel oxide from the regeneration chamber to the reaction chamber.

13. The system of claim 12, further comprising a riser column.

14. The method of claim 1, wherein the solid support comprises aluminum oxide.

15. The method of claim 1, wherein the solid support comprises magnesium oxide.

16. The method of claim 1, wherein the solid support comprises silicon oxide.

17. The method of claim 5, wherein the promoter comprises an oxide.

18. The method of claim 5, wherein the promoter comprises lanthanum(III) oxide.

19. The method of claim 5, wherein the promoter comprises cerium(III) oxide.

20. The method of claim 5, wherein the promoter comprises platinum(II) oxide.
